(19) United States
(12) Patent Application Publication
(10) Pub. No.: US 2013/0272152 A1
(43) Pub. Date: Oct. 17, 2013

(54) METHOD FOR TESTING AN AMPLIFICATION PATH FOR TELECOMMUNICATIONS SATELLITE REPEATER

(71) Applicant: EUTELSAT S A, Paris (FR)

(72) Inventors: Alessandro Le Pera, Issy Les Moulineaux (FR); Frederic Piro, Paris (FR)

(21) Appl. No.: 13/864,736

(22) Filed: Apr. 17, 2013

(30) Foreign Application Priority Data
Apr. 17, 2012 (FR) 1253525

(51) Int. Cl. H04B 7/185

(52) U.S. Cl. CPC H04B 7/18513
USPC 370/252

(57) ABSTRACT

A method for testing an amplification path of a repeater for a satellite for broadcasting the usable signals, the amplification path making it possible to frequency amplify usable signals from a plurality of communications channels, the channels being situated in a first frequency band, the amplification path being adapted to the first band, wherein the satellite includes a signal generator of a subsystem that enables generation of telemetry data to a second transmission antenna for reception thereof on Earth, the method including defining a test signal that includes the selection of a carrier frequency situated in the first frequency band; configuring the repeater to enable transmission of the signal generated by the signal generator to the amplification path; switching of the test signal amplified via the amplification path to the second transmitting antenna.

### TECHNICAL FIELD

The technical field of the invention is directed to methods for testing the amplifier chain in a telecommunications satellite repeater, wherein the satellite may be in a testing phase prior to final launch into orbit or during the operational phase at any point in the service life thereof.

The invention relates more particularly to a method for testing at least one travelling wave tube in an amplifier chain of a satellite repeater. The technical field relates to tests that can be carried out without interrupting service while minimising the degradation caused in particular by interference from neighbouring systems or interference emanating from the system itself.

### RELATED ART

When a telecommunications satellite is launched into its operating orbit, a certain number of tests must be carried out to ensure that all functions are validated before the satellite is rendered operational. Occasionally, various tests must also be conducted during the operational phase of the satellite. These tests must preferably be performed without interrupting service, particularly for the purposes of the organizations operating the broadcast channels that pass through the satellite.

Telecommunications satellites generally serve as repeaters, that is to say they re-transmit over a predefined area a signal sent that has been sent to the satellite for a broadcast application.

The satellite comprises an equipment package that makes up, for example, a system for controlling, processing, amplifying, addressing and broadcasting signals. If a part of this package is faulty or fails, it is important to know the reason for the failure and to test certain components.

One particularly sensitive piece of equipment is the amplifier chain, which may include one or more amplification channels, which would correspond to a significant loss of the satellite's capabilities.

A satellite repeater amplification path generally includes a travelling wave tube. This is a wideband amplifier with very low background noise. A telecommunications satellite generally includes a number of paths corresponding to channels of a given frequency bandwidth. Each channel can be rented or used by broadcasters or operators. Therefore, it is important for each path to be independent and that the channels are separated from each other.

An architecture relating to an amplification path generally comprises a first variable gain amplifier, called an ALC, of which the gain is calculated dynamically to obtain a fixed output power for example, and an amplifier, called a TWT, which corresponds to the travelling wave tube, these two items being connected in series.

When several amplification paths are used in a repeater, the system includes at least one multiplexer and a communication channel switching system that enables the various channels to be aggregated in the various amplification paths.

When testing the amplification paths, it is important to obtain extremely accurate measurements and to eliminate all signals that may give rise to incorrect calculations.

Currently, power tests are carried out by defining and selecting a test signal to be sent from the earth to the satellite. The test requires that the repeater be configured beforehand, particularly with regard to the amplification path to be tested. When the repeater includes multiple amplification paths, a sequence of tests has to be parameterised for multiple paths. Each path is configured according to the purpose of the test that is to be performed.

For example, in a first configuration the TWT amplifiers may be configured in a mode referred to as FGM, with which a fixed gain may be maintained for the amplifier chain.

In a second configuration, the amplifiers can be configured in such manner that the output power is at its maximum at the output from the amplifier chain, in this configuration the power output can be regulated via a downlink control to guarantee that a certain power level is received by the amplifiers.

In a third configuration, the amplifiers can be configured using ALC amplifiers in order to maintain a constant output power at the output from the amplifier chain. The characterising features of ALC amplifiers is that the variable gain control thereof is carried out automatically and dynamically on the basis of a input power level received and a desired output power. The advantage of this configuration is that it dynamically maintains a fixed output power at the amplifier chain output.

One problem is associated with the interference from neighbouring systems, which sometimes use the same frequency bands as the system that is being tested as well as that of the test signal. The neighbouring system may introduce errors into the calculation of dynamic gain for example because the power of the interference is taken into account in the amplifier chain.

Therefore, these tests must be carried out at night, for example, or it is occasionally necessary to wait until a neighbouring system passes out of range or changes its broadcast channel.

One solution consists in reconfiguring the multiplexer and the switching matrix to selection a different frequency band in order to reduce the influence of interference on the tests being carried out.

When the tests are carried out before the satellite is finally launched into orbit, the period for which the tests are performed on the amplification paths is short, and the satellite may be in a configuration that is not ideal for carrying out amplification tests.

In this case, it may be necessary to find a point in the orbit at which no interference exists and where the neighbouring systems will not be interfered with by the test signals as they are transmitted and received by the satellite.

Occasionally, an orbit point of the satellite must be found that is quite distant from the final orbit of said satellite, and this involves a certain cost in terms of time and for conducting the test.

Moreover, it is also possible that the point in the orbit at which the tests can be carried out may no longer be compatible with the position of the ground station.

Another solution, as noted previously, is to carry out the tests at night or to wait for “free” windows in an environment that is becoming more and more cluttered in the orbits of telecommunications satellites. However, this solution places an increased burden on the personnel tasked with testing the satellite repeater.

### SUMMARY OF THE INVENTION

The drawbacks cited in the preceding may be solved by the invention.

The object of the invention relates to a method for testing an amplification path for repeater on a satellite that is connected on the one hand to at least a first antenna for receiving useful signals and a second transmission antenna for broadcasting said useful signals. The amplification path enables the useful signals from a plurality of communications channels to undergo frequency amplification, wherein the channels are located in a first frequency band. The amplification path is adapted to the first band. The satellite further comprises at least one generator of subsystem signals with which telemetry data may be generated to a second emitting antenna for their reception on Earth.

The test method comprises the steps of:
defining a test signal that includes the selection of a carrier frequency situated in the first frequency band;
configuring the repeater to enable:
   transmission of the signal generated by the signal generator to the amplification path;
   switching of the test signal to the second transmission antenna after it has been amplified in the amplification path;
analysing the parameters of the signals that have been defined and amplified by the amplification path and emitted by the transmission antenna after receipt of signals from the Earth.

One advantage of the method according to the invention is that it eliminates interference from neighbouring systems because the test signal is generated on board the satellite, it is no longer transmitted from Earth.

Another advantage is that a frequency generator is installed in the satellite and performs a threefold function, in particular:
the first function is to enable management of telemetry commands, particularly by the receiving, decoding and execution of said commands;
the second function is to enable monitoring of the satellite, particularly by transmissions of monitoring data;
the third function enabled by the invention is that of directing the tests of the repeater chains, particularly of the amplification paths by generating signals on board the satellite.

Each channel is advantageously separated from another adjacent channel by a guardband. In this case, the definition of a test signal includes the step o selecting one of the guardbands located between two adjacent communications channels in which the carrier frequency of the test signal is defined.

One advantage of this solution is that it eliminates interference on the useful signals of the communications channels since a guardband is defined.

Finally, the test may be: conducted both before the satellite is put into its operational orbit during the preliminary tests carried out on the satellite repeater, and conducted during the service life of the satellite without necessitating in interruption in the service thereof on the amplification path that is being tested.

The repeater advantageously comprises a series of amplification paths, wherein the amplification path for testing is selected by means of a configurable switching matrix that serves to route the test signal from the guardband to the amplification path of the repeater to be tested, wherein the method includes a step of selecting the amplification path that is to be tested.

An output switch advantageously enables the test signal output from the amplification path to be routed to the second transmission antenna.

Each amplification path advantageously includes a travelling wave tube.

An advantage of this solution is that it makes it possible to test the travelling wave tubes, which are essential and highly sensitive components of the amplification paths of the satellite repeater. A switching matrix for the signals in the various travelling wave tubes enables the output from the telemetry signal generator to be configured to the tube to be tested.

The test signal advantageously includes CW type modulation.

The test signal advantageously includes spread spectrum modulation.

The method advantageously comprises a step of activating and parameterising the test procedure on the basis of a telemetry command sent from a ground station.

### BRIEF DESCRIPTION OF THE DRAWING

Further features and advantages of the invention will become evident upon reading the following detailed description with reference to the accompanying drawing, in which:

FIG. 1 shows a satellite repeater chain comprising an amplification path;

FIG. 2 shows adjacent channels in a plurality of amplification paths;

FIG. 3 shows a satellite repeater chain comprising a plurality of amplification paths;

FIG. 4 shows a satellite repeater chain in which the chain for processing telemetry signals is represented;

FIG. 5 shows a detail of the telemetry signal processing components in the satellite repeater chain;

FIG. 6 shows a PLL type frequency synthesiser that is able to be used in the signal generator.

### DESCRIPTION

The method according to the invention enables a test signal to be generated for carrying out a test of the amplification paths of a satellite on the basis of a frequency generator installed on board the satellite.

One advantage is to generate a test signal directly on the satellite, not longer at the ground station.

One notable feature of the invention is that it uses a generator that is already being used for telemetry functions, denoted in this case by TM. When the telemetry subsystem comprises multiple generators, the generators are denoted with TMi, where i serves to identify the different generators by number.

In general, the signal generator of the telemetry subassembly serves to provide monitoring of the satellite continuously throughout the service life thereof, a frequency generator may be used to generate command or monitoring signals for transmission to a ground station.

The method according to the invention enables a test programme of the repeater chain to be carried out, particularly regarding the amplification paths of the repeater, by the generation of a test by a generator TM of the telemetry command management subsystem.

One advantage is that a first link with generator TM of the telemetry subsystem may be realised with a switch that enables the generated signals to be routed to at least one amplification path normally from the amplification paths used to amplify the useful signals of the repeater.

A second link enables the amplified test signal to be picked up and routed to the antenna that is normally used by telemetry.

One advantage is that the antennas used to transmit and receive the telemetry signals enable good coverage of the satellite on Earth. It is always possible for a ground station to remain in contact with the satellite via that path.

Thus, the tests may be carried in any orbit as soon as the telemetry path is operational.

The method according to the invention enables a test signal to be generated on a frequency situated in a guardband, the guardband being a band that is not used by the communications channels of a satellite repeater.

Consequently, the test signal is not disrupted at the receiver input by interference from neighbouring systems.

The test signal is also not disrupted by interference that may originate from the signals of the satellite's communications channels, since a guardband is used.

A notable feature of the method according to the invention is that of switching the test signal into an amplification path of the repeater in order to test said path by analysing the amplified signal.

One configuration of the repeater enables the test signal to be routed to a transmitting antenna of the telemetry command management subsystem after said test signal has been amplified. In fact, the telemetry command management subsystem comprises an array of transmitting and receiving antennas for receiving and transmitting telemetry commands.

A method according to the invention enables a part of this subsystem to be used to generate a test signal and transmit it to a ground station. The amplified test signal is then analysed at a ground station on Earth.

One benefit is the ability to use the chain with which telemetry data is transmitted and not the antennas with which the operators' useful signals are transmitted. An advantage of the invention is that it enables an amplification path to be tested without interrupting service for an operator that is using a communication channel to broadcast useful signals, or also enables tests to be conducted prior to putting the satellite into operational orbit.

As was noted in the preceding, the satellite comprises a subsystem for managing the remote control of the satellite, particularly through the use of a telemetry path. The method according to the invention enables transmitter TM of the satellite's telemetry subsystem to be used for conducting a test on a selected amplification path.

Two antennas enable commands transmitted from Earth to be received and to actuate or act on components of the satellite. The two antennas may also be used to re-transmit telemetry data back to Earth, particularly data relating to a functional state of the satellite or an acknowledgement of data corresponding to indicators relating to the life of the satellite.

According to an embodiment of the invention, the test signal may be routed to the two telemetry antennas, generally denoted +Z and −Z. With this configuration, tests may be conducted on the amplification paths particularly with the aid of an omnidirectional transmission.

This embodiment is particularly useful in the preliminary phase corresponding to the period prior to placement in final orbit. This phase, also called LEOP, which stands for “Launch and Early Orbit Phase”, is critical. During this phase, which is quite short, a number of tests must be carried out to confirm that all equipment is functioning correctly, at the same time eliminating interference from neighbouring systems.

The two antennas of the telemetry subsystem are able to cover all directions. Consequently, all of the signals transmitted by the antennas may thus be received by a ground station.

One advantage of the method of the invention is that it enables a signal to be generated by a signal generator TM that was initially intended for telemetry to direct said signal to at least one amplification path and then to route it to a transmitting antenna originally designed for telemetry signals. Analysis of the signal received at a ground station enables the amplification path to be tested, particularly by analysing certain parameters of the received signal. By way of example, the amplitude of the signal and/or its power upon reception enables a conclusion to be drawn about the amplifier chain. This further supports the argument for testing the travelling wave tubes in this way, since they are subsystems of the amplification paths.

The method of the invention enables tests to be carried out during the phase preceding placement of the satellite in its operational orbit, but also enables tests to be carried out while the satellite is in operation and providing the broadcast of useful signals for the operators thereof, wherein the useful signals are broadcast in dedicated communications channels.

Transmitter TM is capable of generating at least one test signal that may be modulated on the basis of a carrier frequency. Within the context of the method according to the invention, transmitter TM is capable of generating a carrier frequency within a given band. In particular, a particularly advantageous band is a guardband situated between the communication channels of the useful signals that pass through the repeater, There are generally multiple guardbands when multiple channels are used for useful signals.

A guardband may be situated between two adjacent channels and services to ensure that service is not interrupted while the amplification path is tested.

Transmitter TM is able to generate a test signal modulated by a carrier frequency chosen for example from the Kᵤ band. This band is particularly useful for satellites and for testing the amplification paths for which the satellites are designed. The modulation used may be defined in a radio telegraphy mode of CW type modulation.

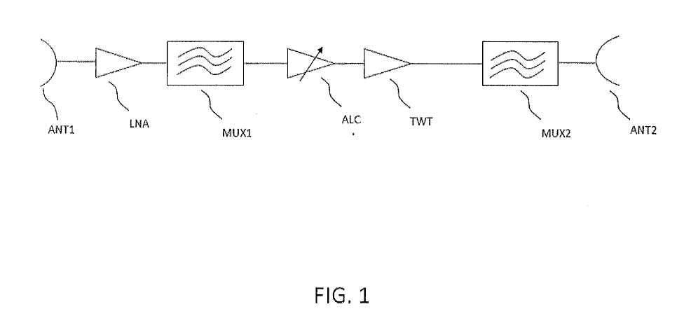

FIG. 1 shows a primary chain of a repeater that serves to receive, process, amplify and broadcast useful signals. The primary chain comprises a receiving antenna ANTI for receiving useful signals. It is possible that a plurality of transmitting antennas may be provided on a satellite, the method of the invention is not limited to a certain number of receiving antennas of the repeater. Only one antenna is represented in the embodiment of FIG. 1.

A plurality of communications channels are defined and may be used to transmit the useful signals. The communications channels are generally assigned to different operators. All of the signals in each of the channels are receivable by antenna ANT1 or a plurality of antennas.

The primary repeater chain comprises a low noise amplifier denoted by LNA. A first multiplexer MUX1 serves to multiplex various communications channels in a single amplification path. This amplification path is represented here by a variable amplifier denoted by ALC and a travelling wave tube denoted by TWT.

Generally in a repeater, a plurality of amplification paths is configured with an input switch upstream and an output switch for allocating an amplifier chain to the data that has been multiplexed together. In FIG. 1, only one amplification path is represented. An output mutiplexer enables the communications channels of the amplified signals to be directed to a suitable transmitting antenna ANT2. There may be only one transmitting antenna ANT2 or multiple transmitting antennas. Particularly if transmitting antenna ANT2 is associated with an operator in order to cover a geographical region, it is possible that signals may be routed to a dedicated transmitting antenna at the output from an amplification path.

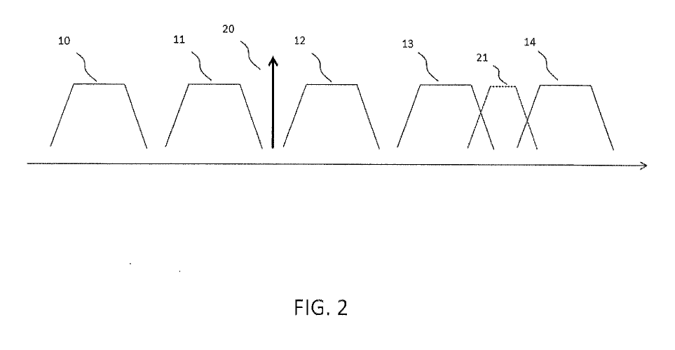

FIG. 2 represents a plurality of communication paths, denoted 10, 11, 12, 13 and 14, which are transmitted within an amplification path such as is shown in FIG. 1.

The width of the frequency band that is able to enter the amplification path makes it possible to amplify all of the signals in each of the communication paths shown.

Multiplexer MUX1 serves to sequence all of the useful signals received from different channels and to sequence them to the same amplification path.

The method of the invention may be adapted for use with a satellite repeater comprising a plurality of amplification paths.

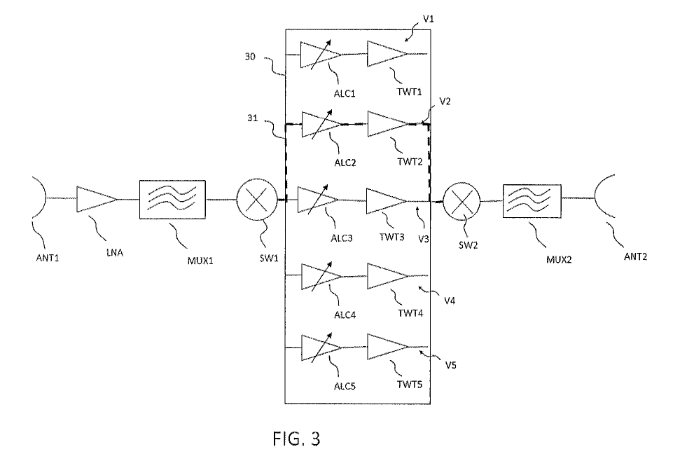

FIG. 3 illustrates the case in which the repeater comprises an amplification path array 30. Each path comprises a variable amplifier, denoted ALC1, ALC2, ALC3, ALC4, ALC5 respectively. Additionally, each of the paths comprises a travelling wave tube, denoted TWT1, TWT2, TWT3, TWT4, TWT5 respectively in FIG. 3.

In the case of an amplification path array 30, the repeater comprises a switching matrix, also commonly called a “switch” and denoted SWI in FIG. 3. A switch is a matrix that is used to configure the stream of multiplexed data in a given amplification path Vi.

An output switch SW2 at the output from the amplification path serves to route the amplified signals to a demultiplexer MUX2 by which the amplified signals are directed to a dedicated or shared transmitter comprising a transmitting antenna ANT2. Only one receiving antenna ANTI and one transmitting antenna ANT2 are shown in the figures.

With the method according to the invention, it is possible to test an amplification path without interrupting service, particularly with regard to the transmission of useful signals in the communication channels.

With the method according to the invention, it is possible to configure the repeater in such manner as to select an amplification path for testing with the test signal. If the repeater comprises a plurality of amplification paths and some or all of the array of amplification paths are being tested, a sequencing plan may be defined in order to define the sequence tests for the amplification paths.

In this case, the test sequence includes:
generating a test signal routed to an amplification path;
transmitting the amplified signal to a ground station;
receiving the signal on Earth for analysis.

These three steps are then performed on another amplification path.

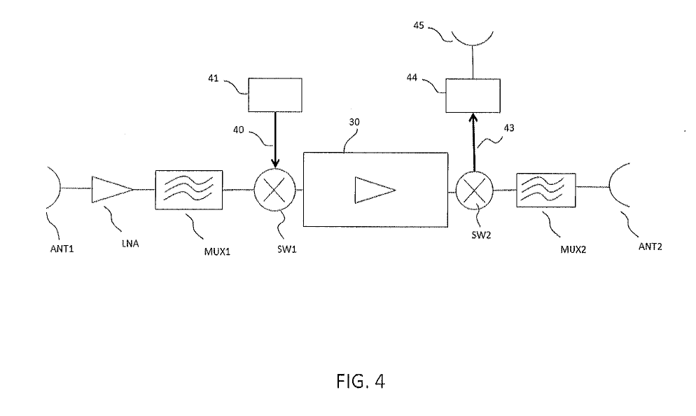

FIG. 4 shows a chain of a satellite repeater in which amplification path array 30 is represented by a single block. With the method according to the invention it is possible to define a test signal and a modulation using a signal generator TM of a subsystem 41, 43 for managing telemetry commands.

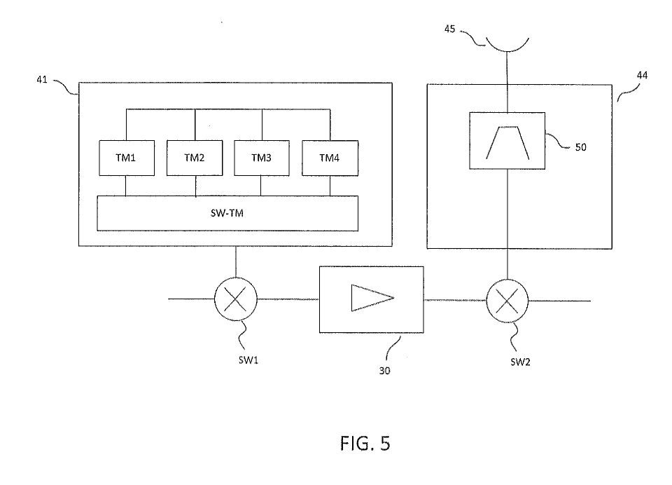

Signal generator TM is not shown in FIG. 4. Instead, FIG. 5 shows a subsystem 41, 44 in which a plurality of signal generators TM1, TM2, TM3, TM4 are represented.

The method according to the invention is compatible with any repeater that includes at least one signal generator TM of a telemetry command management subsystem.

A receiving antenna that is capable of receiving telemetry commands may be used if the method of the invention is activated by a command from Earth.

A transmitting antenna 45 enables telemetry commands to be transmitted to a ground station.

For the purposes of the method of the invention, a test signal is generated on the satellite by a signal generator TMi. Thus, it is not transmitted from the ground station even if such a configuration is compatible with the method of the invention.

The receiving antenna is therefore not essential for carrying out the method of the invention. On the other hand, a preliminary step may be provided in which a command for activating the method is sent from the Earth to the telemetry command management subsystem to initiate the method of the invention. In the present case, a test signal can be generated by a signal generator TM_{i, i∈[4]}.

An advantage of the method of the invention is that it may be realised on the basis of a link from at least one signal generator TMi to multiplexer MUX1, or directly to switch SW1 so that a test signal is routed in a selected amplification path Vie.

The dashed line in FIG. 3 represents a connection 31 corresponding to the selection of amplification path V2, which includes an amplifier ALC2 and a travelling wave tube TWT2.

If telemetry command management subsystem 41 includes a plurality of signal generators TMi, then a switch SW-TM may be used to route the test signal from a selected signal generator to switch SW1 or multiplexer MUX1 of the amplifier chain.

With the method according to the invention, it is possible to configure a signal generator TMi and the type of signal modulation so as to define a suitable test signal. In particular, the method of the invention makes it possible to define a carrier frequency in a Kᵤ band. In order to prevent the any interference from disrupting the communication channels as they pass through the repeater. the carrier frequency is selected in a guardband, that is to say a band of frequencies that is situated between two communication channels and which uses bands that are close or substantially adjacent, wherein the signals in each communication channel take the same amplification path.

The guardband may have a width of 5 MHz, for example, with a carrier frequency substantially close to 11 MHz. Modulation may be of the CW type.

Once the test signal has been defined and signal generator TMi has been configured, the connection of the signal generator being provided to an input switch SW1 of the amplification paths, the switching matrix or input switch SW1 may then be configured to address the test signals generated by signal generator TMi to an amplification path Vi that is to be tested.

With the method of the invention, a test signal may be routed in an amplification path to be tested, and the amplified signal may be picked up at the output from the repeater chain by means of an output switch SW2, The output switch may be configured beforehand so as to route the amplified signal via amplification path Vi to a transmitting antenna 45 connected to telemetry command management subsystem 41, 44.

If required, according to an optional step of the method the amplified test signal may be shaped by means of a “wideband” filter 50 with which a test signal with CW modulation may be routed to the downlink over a wide bandwidth, particularly a width of 2 GHz.

With the method according to the invention, it is possible to define and select a test frequency that avoids any interference with the signals of the multliplexed channels in an amplification path.

In one particular embodiment, the signal generator comprises a “phase-locked loop”, or PLL type frequency synthesiser.

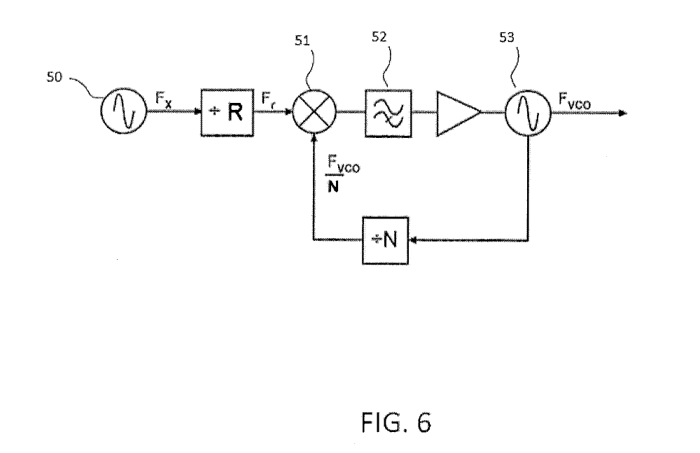

FIG. 6 shows an example of this embodiment of a type of synthesiser that may be used in a signal generator.

A PLL type frequency synthesiser such as is represented in FIG. 6 enables the ratio between the primary oscillator branch (division by R) and the signal coming from a voltage controlled oscillator, generally denoted by VCO (division by N) to be modified in such manner that if the values of R and N are changed a wide selection of output frequencies becomes available.

A phase detector 51, a filter 52 and an amplifier are shown in the processing chain of signal Fᵣ and F_{VCO}/N of FIG. 6.

The carrier frequency of the test signal may be generated from a frequency agile signal generator within a predefined band.

In a variant of the embodiment, the signal generated by signal generator TMi may undergo spread spectrum modulation in order to further limit any possible interference between the test signals and the usable signals passing through amplification paths Vi of the satellite repeater.

An advantage of the method according to the invention is that it makes it possible to carry out essential tests of the system regardless of the orbit of the satellite, and particularly without interfering with usable signals that are passing through the repeater.

Additionally, with the method of the invention it is possible to conduct tests throughout the service life of the satellite in order to verify that an amplification path is operational.

1. A method for testing an amplification path of a satellite repeater, said path being connected to at least one first antenna for receiving usable signals and a second transmitting antenna for broadcasting said usable signals, wherein the amplification path makes it possible to frequency amplify usable signals from a plurality of communications channels, said channels being situated in a first frequency band, the amplification path being adapted to the first band, wherein the satellite comprises at least one signal generator of a subsystem that is configured to enable generation of telemetry data to a second transmission antenna for reception thereof on Earth, the method comprising:
defining a test signal that includes the selection of a carrier frequency situated in the first frequency band;
configuring the repeater to enable:
transmission of the signal generated by the signal generator
of the telemetry command management subsystem to the amplification path, the signal generator being connected to the amplification path to be tested;
switching of the amplified test signal to the second transmitting antenna via the amplification path, the amplification path being connected to the second transmitting antenna;
analysing the parameters of the signals that have been defined and amplified by the amplification path and emitted by the transmitting antenna after receipt of signals from the Earth.

2. The method for testing an amplification path according to claim 1, wherein each channel is separated from another, adjacent channel by a guardband, the definition of a test signal comprising a selection of one of the guardbands situated between two adjacent communications channels in which the carrier frequency of the test signal is defined.

3. The method for testing an amplification path according to claim 1, wherein the repeater comprises an array of amplification paths, the amplification path for testing being selected with a configurable switching matrix that enables routing of the test signal from the guardband to the repeater amplification path being tested, wherein the method includes selecting the amplification path to be tested.

4. The method for testing an amplification path according to claim 3, wherein an output switch enables the test signal at the output to be routed from the amplification path to the second transmitting antenna.

5. The method for testing an amplification path according to claim 1, wherein each amplification path comprises a travelling wave tube.

6. The method for testing an amplification path according to claim 1, wherein the test signal comprises CW type modulation.

7. The method for testing an amplification path according to claim 1, comprising activating and parameterising the test procedure on the basis of a telemetry command sent from a ground station
